(19) United States
(12) Patent Application Publication
(10) Pub. No.: US 2014/0124527 A1
(43) Pub. Date: May 8, 2014

(54) VENDING MACHINE FOR FRESH PRODUCE

(71) Applicant: SOUTH ESSEX FABRICATING INC., Leamington (CA)

(72) Inventors: Peter Quiring, Leamington (CA); David Knelsen Dyck, Leamington (CA)

(73) Assignee: South Essex Fabricating Inc., Leamington, ON (CA)

(21) Appl. No.: 13/794,106

(22) Filed: Mar. 11, 2013

Related U.S. Application Data
(60) Provisional application No. 61/721,923, filed on Nov. 2, 2012.

(51) Int. Cl. G07F 9/10

(52) U.S. Cl. CPC G07F 9/105; G07F 9/10
USPC 221/150 R; 221/155

(57) ABSTRACT

An automated produce department has a housing at least partially enclosing a display area and a window for viewing the display area. A plurality of produce supports each support a plurality of packages of produce in a vertical stack. The produce supports are disposed in a horizontal array such that the supports cooperate to display produce as a horizontal display viewable through the viewing window. Each of the produce supports have a vertically adjustable platform such that the platforms may be adjusted to position an uppermost package of produce in each of the vertical stacks at a display level generally in a display plane, and the uppermost packages are viewable through the viewing window. A retrieval system retrieves a package of produce from any of the produce supports and delivers the package to an output area.

### CROSS-REFERENCE TO RELATED APPLICATION

This application claims priority to U.S. provisional patent application 61/721,923, filed Nov. 2, 2012, the entire content of which is incorporated herein in its entirety.

### FIELD OF THE INVENTION

The present invention relates generally to vending machines and, more specifically, to an automated produce department suited for storage and vending of fresh produce and other products.

### BACKGROUND OF THE INVENTION

The current approaches to the distribution and sale of fresh produce present many challenges. Produce, by its very nature, is perishable, has a limited shelf life, and is often fragile. Additionally, consumers often place an emphasis on the appearance of produce when making a purchasing decision. Produce that is old or imperfect, or poorly displayed, may be difficult to sell. As such, vendors dedicate significant time and resources to displaying produce and maintaining the display by removing produce with a poor appearance. The transport of produce also presents many challenges. Produce growers pick produce and prepare it for shipping. It is picked and prepared with an expectation that it will be efficiently transported to an end destination. However, produce often travels to several intermediate locations prior to reaching a final retail location. During this time, the conditions under which the produce is stored may be less than optimal, and multiple stops increase the time between picking of the produce and retail sales. A portion of the produce may already be in unsellable condition when it reaches a retail location, requiring the retailer to sort the produce prior to displaying it for sale. In light of this, there is a need for improved methods of produce distribution and apparatus for the vending of fresh produce features.

### SUMMARY OF THE INVENTION

The present invention provides an automated produce department having a housing at least partially enclosing a display area. The housing has at least one viewing window for viewing the display area. A plurality of produce supports are each configured to support a plurality of packages of produce in a vertical stack. The produce supports are disposed in a horizontal array such that the supports cooperate to display produce as a horizontal display viewable through the viewing window. Each of the produce supports has a vertically adjustable platform such that the platforms may be adjusted to position an uppermost package of produce in each of the vertical stacks at a display level generally in a display plane, and the uppermost packages are viewable through the viewing window. A retrieval system retrieves a package of produce from any of the produce supports and delivers the package to an output area.

Some versions include a plurality of vertically adjustable platform systems, each system having a lifting tower with one of the vertically adjustable platforms being disposed on a first side of each tower and another of the vertically adjustable platforms being disposed on a second side of each tower. The plurality of vertically adjustable platform systems may be disposed side by side such that the towers form a central axis of the horizontal array of supports.

The plurality of vertically adjustable platform systems may each further include a first scissors mechanism disposed on a first side of each tower and a second scissors mechanism disposed on a second side of each tower, the platforms each being disposed on an upper end of a scissors mechanism. These platform systems may each include a lifting mechanism disposed generally in the tower, with the lifting mechanism being connected to the platforms for vertically adjusting the position of the platforms.

In some versions, an output conveyer is disposed in the housing adjacent the horizontal array of produce supports, and has a generally horizontal upper surface defining the output area for receiving packages of produce. The checkout area may be defined at least partially outside the housing, and the output conveyer may convey produce to the checkout area. A checkout cover may selectively cover the checkout area, with a closed position preventing access to the checkout area by a customer and an open position allowing access to the checkout area by a customer.

The retrieval system may include a retrieval gantry movable horizontally above the supports and a pickup arm vertically movable to pick up a package from a support and lift the package above the supports. The pickup arm may have a retrieval end.

In some versions of the automated produce department, a climate control system is operable to control the climate in the display area. The climate control system includes a conditioning unit with an inlet and an outlet, and a supply duct in fluid communication with the outlet of the conditioning unit. The supply duct has a plurality of outlets, each outlet being disposed adjacent one of the produce supports.

A high ethylene zone and a low ethylene zone may be defined within the housing, and at least some of the produce supports are disposed in the high ethylene zone and some of the produce supports are disposed in the low ethylene zone. The climate control system may direct airflow within the housing such that air flows from the low ethylene zone to the high ethylene zone and then into the inlet of the conditioning unit. The conditioning unit may neutralize or remove at least some of the ethylene from the air before the air flows through the supply duct. The conditioning unit may be disposed toward a first end of the housing, with the high ethylene zone being closer to the conditioning unit and the low ethylene zone being farther from the conditioning unit.

In some embodiments, the automated produce department includes an ordering terminal for use by a customer, the ordering terminal including an input screen for inputting a selection and a payment mechanism for accepting payment.

### BRIEF DESCRIPTION OF THE DRAWINGS

FIG. 1 is a perspective view of an embodiment of an automated produce department in accordance with the present invention;

FIG. 2 is a perspective view of the department with the outer walls removed;

FIG. 3 is a perspective view of the department with doors opened for access to the display area;

FIG. 4 is a perspective view of a checkout area that forms part of some embodiments of the present invention;

FIG. 5 is another perspective view of the checkout area;

FIG. 6 is a flowchart illustrating a method of operation of the present invention;

FIGS. 7A-7D is another flowchart illustrating a method of operation of the present invention;

FIG. 8 is a perspective view of a vertically adjustable platform system that may form part of some embodiments of the present invention;

FIG. 9 is a perspective view of part of a gantry system that may form part of some embodiments of the present invention;

FIG. 10 is a perspective view of a pickup arm that may form part of a retrieval system of the present invention;

FIG. 11 is another perspective view of the pickup arm;

FIG. 12 is a detail view showing cameras that may form part of a vision system;

FIG. 13 is a schematic top view of an automated produce department in accordance with certain embodiments of the present invention;

FIG. 14 is a top view similar to FIG. 13 showing airflow for certain embodiments;

FIG. 15 is a schematic side view showing airflow for certain embodiments;

FIG. 16 is a schematic top view of a vending system in accordance with a further embodiment of the present invention;

FIG. 17 is a side view of a portion of the system of FIG. 16, taken at arrows A; and

FIG. 18 is a flow chart illustrating a farm-to-fork process in accordance with the present invention.

### DETAILED DESCRIPTION OF THE PREFERRED EMBODIMENTS

The present invention provides an automated produce department suitable for the storage, display, and retail sale of fresh produce, as well as for other perishable and non-perishable items. The present invention also provides a method of distribution of fresh produce that reduces the delays between picking and sale, and reduces the handling of the produce, thereby providing an opportunity to improve the freshness, appearance, traceability, and safety of the produce.

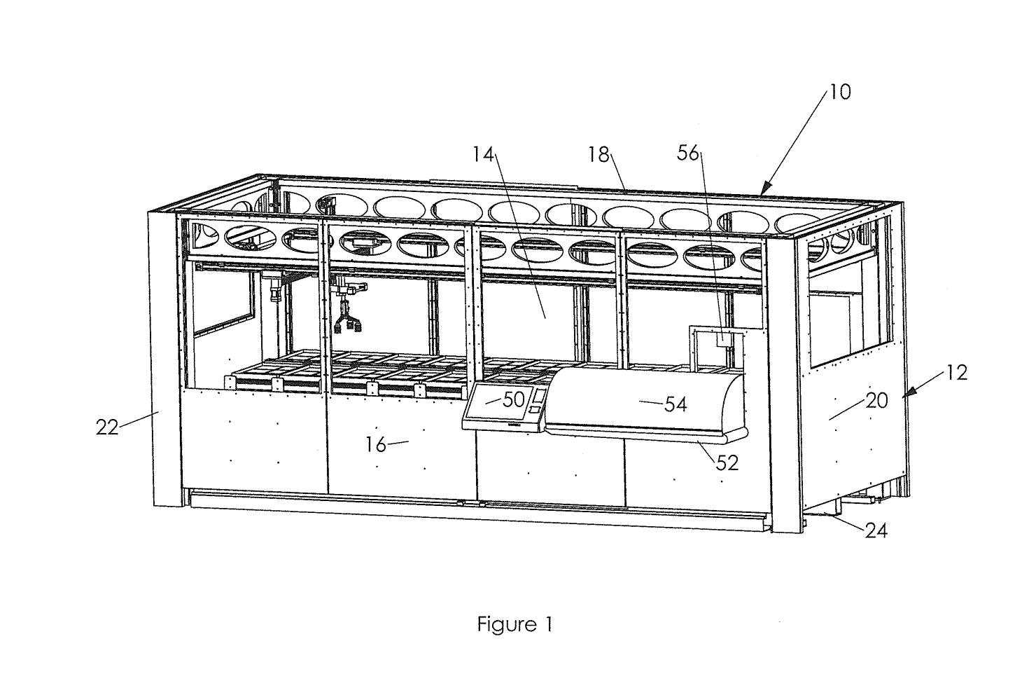

Referring to FIG. 1, an embodiment of an automated produce department in accordance with the present invention is shown generally at 10. The machine includes an insulated housing 12 that encloses a display area 14 for displaying produce to customers. In the illustrated embodiment, the housing is a large rectangular box having a front wall 16 and a rear wall 18 interconnected by sidewalls 20 and 22. The housing also has a base 24 enclosing the bottom of the housing and a top enclosing the upper end of the housing. The top is removed in FIG. 1.

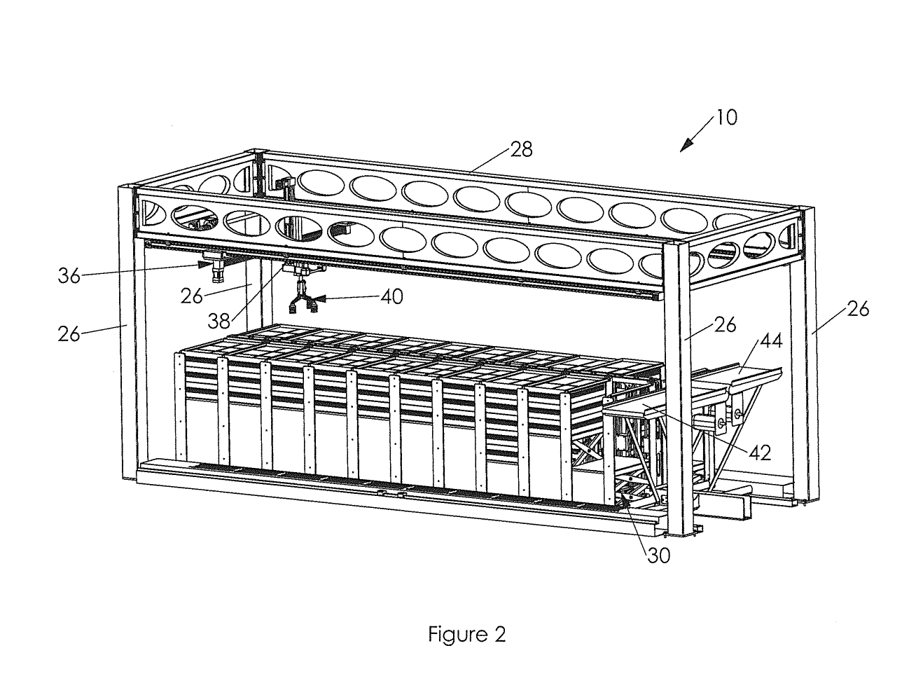

In this embodiment, the housing includes a support frame that supports the outer walls and components of the machine. FIG. 2 shows the machine 10 with the front, back and sidewalls removed, to allow the internal structure and components to be viewed. As shown, an internal frame includes four legs 26 at the four corners of the housing, and an upper perimeter frame 28 that extends between the legs 26 and defines the upper end of the machine. In some embodiments a uni-body design is used, wherein the housing itself is structural and the legs 26 may be eliminated. In some embodiments, the housing has a depth, from the front wall 16 to the rear wall 18 of approximately 86 inches, a length from the sidewall 20 to the sidewall 22 of approximately 216 inches, and a height of approximately 98 inches. The housing may be designed to allow lifting of the overall machine either with a forklift or by lifting hooks interconnected with the upper end of the frame. In another embodiment, a manually mobile or motorized attachable trolley system is provided at each end of the housing. Each of these trolley systems comes with a hand pump hydraulic lift attached to caster wheel assemblies, in order to raise the machine and move it onto a transport system without a forklift or crane.

The automated produce department 10 is designed to display fresh produce in a horizontal display, visible to customers standing outside of the housing. The housing preferably has multiple windows, including windows in the front wall 16 and the end walls 20 and 22. Windows may also be provided in the back wall if there is room behind the automated produce department to walk around it. However, more typically, windows are not necessary in the back side. Mirrors may be provided, if desired. Lighting is preferably included inside the housing, with the lighting configured to make the produce look appealing.

Referring again to FIG. 2, the machine 10 includes a plurality of produce supports arranged in a horizontal array. One such produce support is indicated at 30. In the illustrated embodiment, twenty produce supports are provided in a two deep by ten wide horizontal array. Alternatively, other horizontal arrays may be provided, such as one deep and/or less than ten wide. However, it is preferred to provide a large display area to allow the display of a diverse selection of produce.

In the illustrated embodiment, each produce support is configured to support a plurality of packages of produce in a vertical stack. For example, the stack of produce on support 30 includes multiple produce trays 32 each holding four packages of produce 34. The number of packages per tray depends on the amount and type of produce in each package and the size and shape of the package. Preferably, different types of produce, or other products, are provided in different stacks. Each produce support includes a vertically movable platform such that the platforms may be adjusted to positions that place each of the trays 32 of the produce packages generally at the same level, which may be referred to as a “display plane”. As shown, some of the produce supports have larger stacks of produce trays than other of the produce supports, but the uppermost tray of all the supports is in the same general plane. Preferably, this provides a generally horizontal display of a plurality of packages of produce, which is aesthetically pleasing to consumers.

The automated produce department includes a retrieval system for retrieving packages of produce from any of the produce supports and delivering each package to an output area. In the illustrated embodiment, the retrieval system includes a gantry 36 that moves horizontally above the produce supports 30. The gantry 36 supports a pick-up arm 38, with the arm having a retrieval end 40 for picking up packages of produce. The gantry 36 is operable to move the pick-up arm forward and back and side-to-side, and the pick-up arm moves vertically upwardly and downwardly, so as to move down and place the retrieval end 40 in contact with a particular package of produce. The retrieval end then grasps the package, the pick-up arm moves vertically upwardly and then the gantry 36 moves the pick-up arm to the output area. In the illustrated embodiment, an output conveyor 42 defines the output area, which is adjacent to the horizontal array of produce supports 30 and generally at the same level as the display plane. The pick-up arm moves downwardly so as to place the package onto the conveyor 42 and the retrieval end releases the package. The retrieval system can then retrieve additional packages of produce.

When all of the packages 34 from a tray 32 have been removed, the retrieval system may retrieve the empty tray 32 and move it to a disposal area. In the illustrated embodiment, the disposal area takes the form of a disposal conveyor 44. Alternatively, empty trays may be stacked in a stack in a disposal area. The disposal conveyor preferably moves empty trays to a position outside the housing for later use, disposal or recycling.

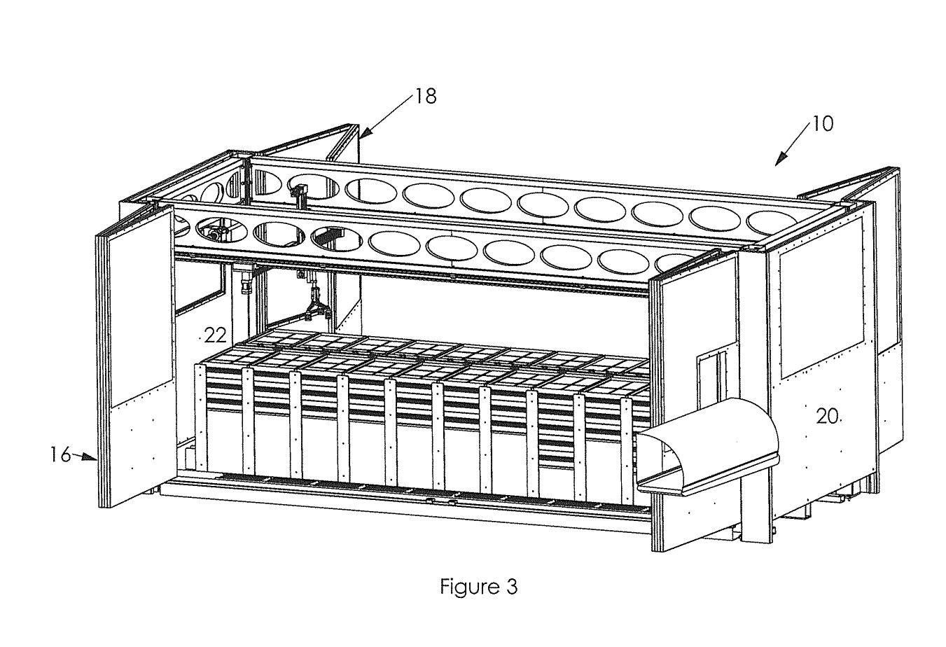

As will be clear to those of skill in the art, it is necessary to restock the machine 10 with fresh produce on a regular basis. In some versions, both the front wall 16 and rear wall 18 include large doors providing access to the display area for restocking and/or servicing of the machine. FIG. 3 illustrates an embodiment of the present invention wherein almost the entirety of the front wall 16 and rear wall 18 are formed by large bi-fold doors. These doors may be constructed in a variety of ways, though it is preferred that they seal and lock when closed so as to reliably contain the conditioned atmosphere inside the display area and prevent access to the display area by non-authorized personnel.

Referring again to FIG. 1, the automated produce department may have an ordering terminal 50 outside the housing. The terminal 50 allows a customer to select one or more packages of produce. The machine then retrieves the packages and moves them to the output conveyor 42. In this embodiment, the output conveyor 42 communicates with a checkout conveyor 52. Packages of produce may be moved to the checkout conveyor as each is retrieved or after multiple packages have been retrieved. In the illustrated embodiment, a checkout cover 54 selectively covers the checkout conveyor 52 to prevent access to the produce until payment has been made. The checkout cover 54 preferably has an assist system to make it easy to lift, the cover remains in a raised position until all products are removed, and it is then closed with a soft closing feature. A scanner 56 may be provided for scanning the packages of produce on the output conveyor or checkout conveyor to confirm that the correct type of produce has been retrieved.

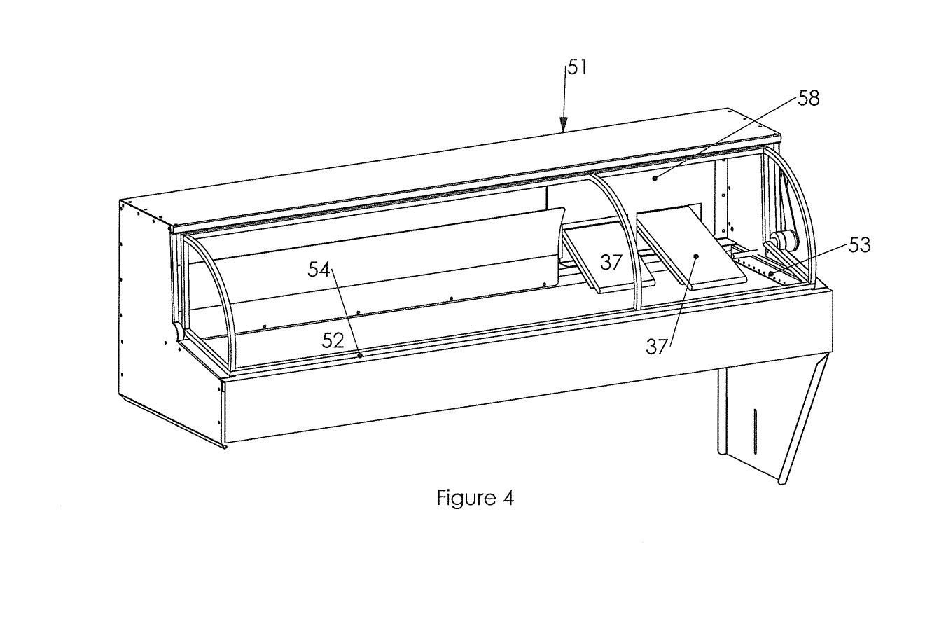

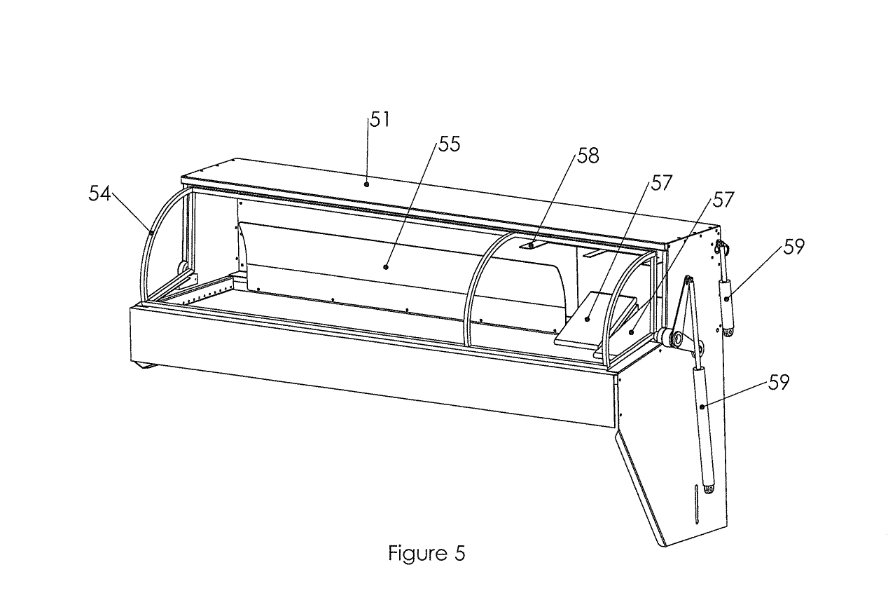

Referring now to FIGS. 4 and 5, one version of a checkout area will be described in more detail. In this version, a checkout housing 51 encloses the checkout area. It includes a checkout cover 54 that selectively allow access to a checkout conveyor 52 housed in the housing 51. In this version, sensors 53 are provide for sensing if product is on the surface of the checkout conveyor 52. The sensors in this embodiment take the form of a plurality of light emitters and sensors at each end of the conveyor, that provide light beams extending just above the surface of the conveyor. This is sometimes referred to as a light curtain. If product is on this surface, some of the light beams are interrupted. A shield 55 is provided along the rear edge of the conveyor to prevent product from being pushed too far to the back. The cover 54 moves behind the shield 55 when it is in the open position, as in FIG. 4. Ramps 57 extend between the output conveyor 42 and the checkout conveyor 52, to assist in the smooth movement of product from one conveyor to the other. The ramps 57 may take a variety of forms. The ramps 57 are preferably positioned such that the light beams from the sensors 53 pass under the ramps and are not interrupted by the ramps.

A security gate 58 is provided to close off the opening between the checkout area and the output area. The gate 58 is shown in a closed position in FIG. 4 and an open position in FIG. 5. It fits around the ramps and prevents a customer from reaching into the inside of the machine when the cover 54 is open. Latches maybe provided for latching the cover 54 and the gate 58 in the closed positions, as needed. When access to the checkout conveyor is allowed, the customer may lift the cover or it may be opened using an actuator such as shown at 59. An actuator 59 may also be provided for the gate 58. Though not shown, the machine also includes a control system with a central processing unit operable to control the various parts of the machine.

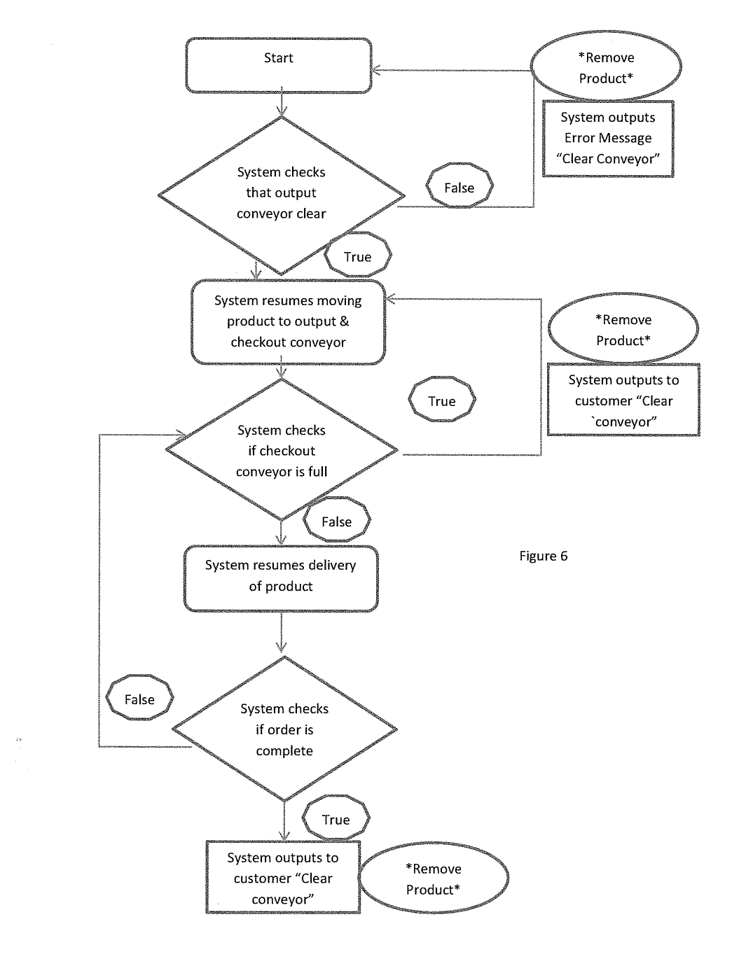

Operation of the output conveyor and checkout area may take a variety of forms. FIG. 6 provides a flowchart with an overview of one approach. When an order is placed, the operation starts at the box labeled “Start”. The control system first checks whether the output conveyor 42 is clear. Normally, the output conveyor would be clear at this stage, but if product or debris is on the conveyor, the system will output an error message causing the conveyor to be cleared. Depending on the situation, this error message could summon an operator to check the machine or the machine may take steps to clear the output conveyor, such as running it in the reverse direction to move anything on the output conveyor 42 to the disposal conveyor 44 or the gantry may retrieve and move anything from the belt. Once the output conveyor 42 is clear, the system proceeds to the step “System resumes moving product to output conveyor and to checkout conveyor”. Then, “System checks if checkout conveyor is full”. If so, the consumer will be notified to clear the conveyor. If not, the “System resumes delivery of product.” Then, “System checks if order is complete.” If it is, the system notifies the customer to clear the conveyor and the process is done. If the order is not complete, the system returns to the step of “System checks if checkout conveyor is full,” as shown.

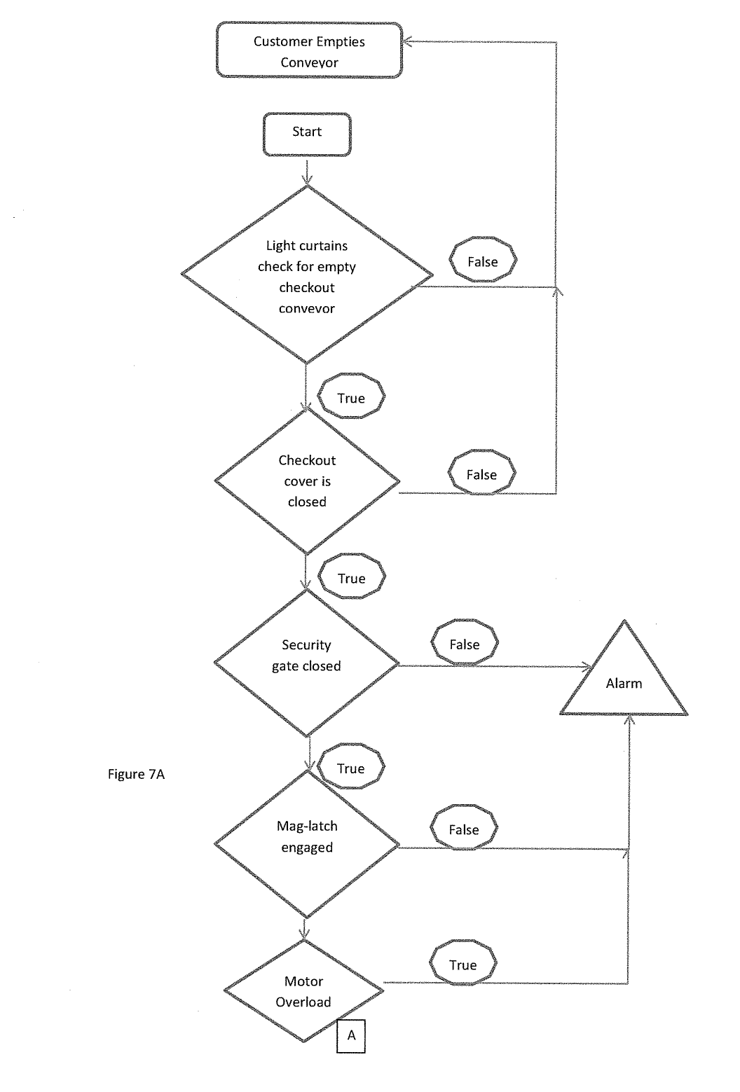

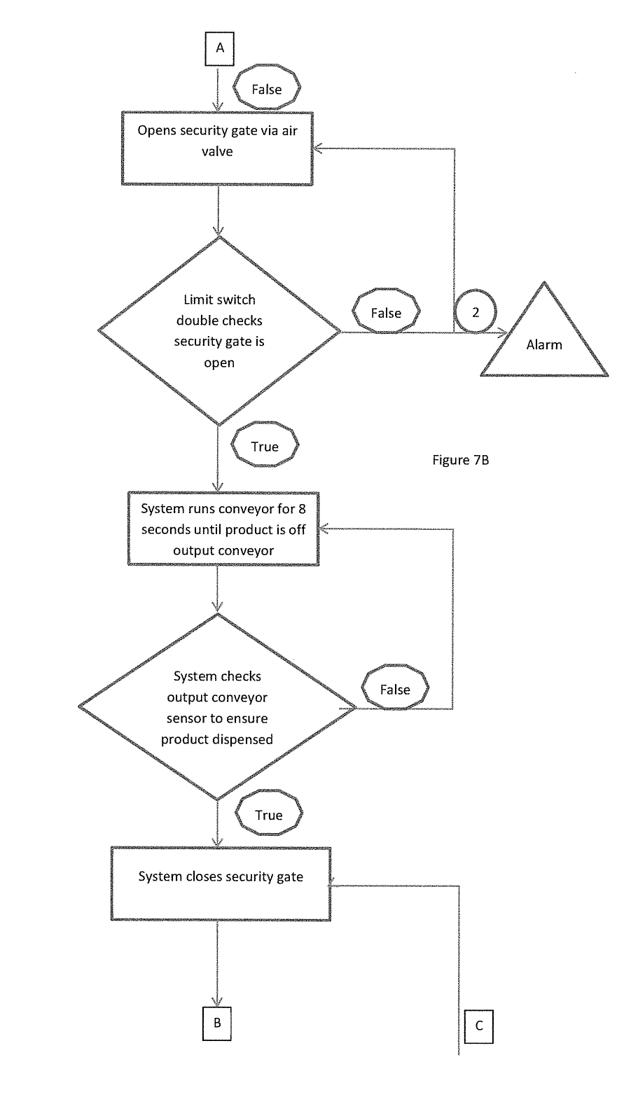

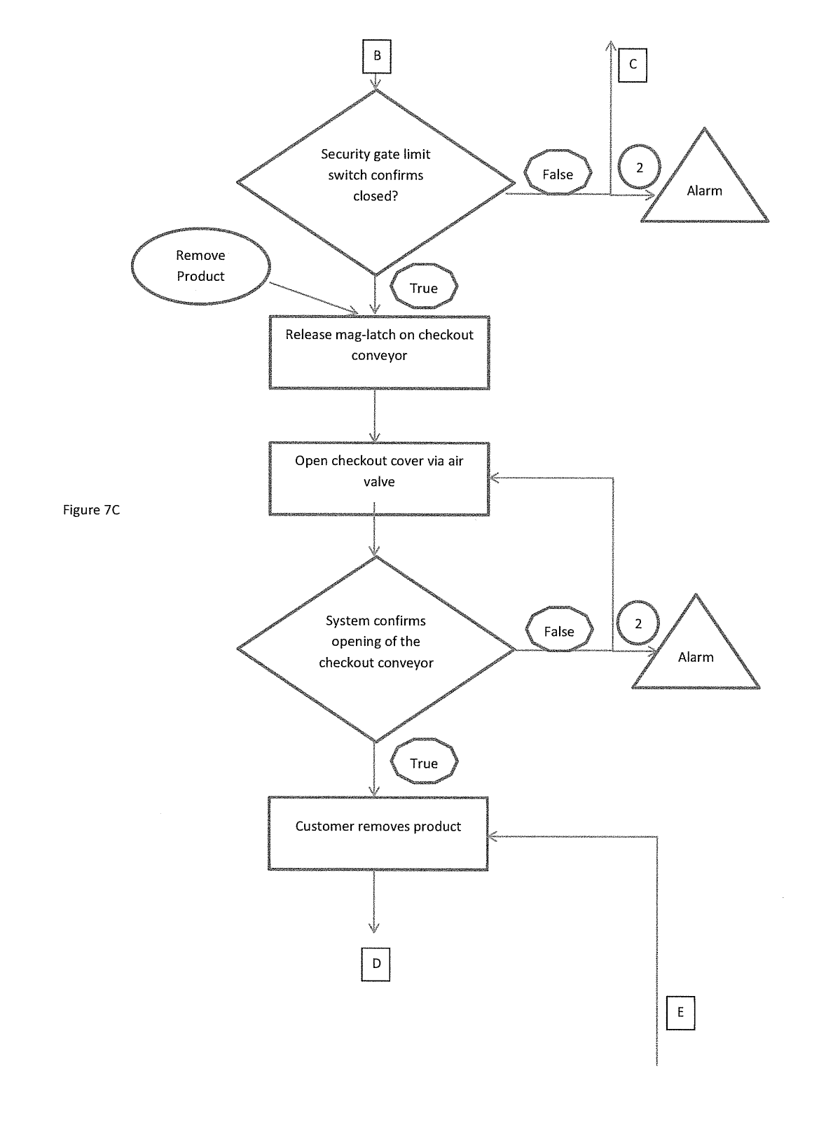

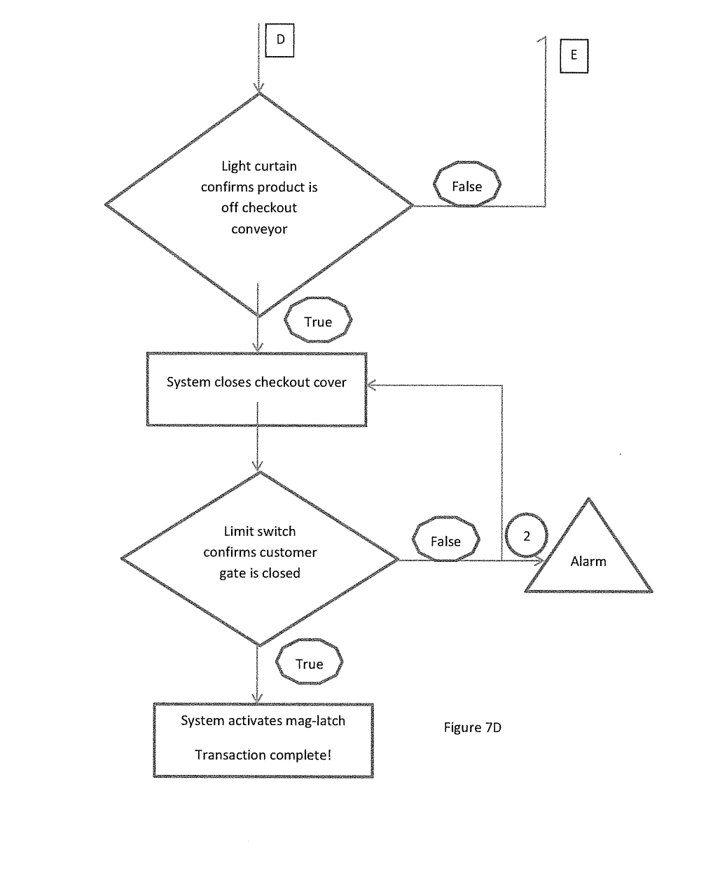

FIGS. 7A-7D illustrates a more detailed process for operation of the conveyors, the checkout cover, the security gate and the latches. The process begins at “Start” and the light curtains 53 check if the checkout conveyor 52 is empty and it is determined if the checkout cover 54 is closed. If either of these is false, the customer is notified to clear the conveyor. If both are true, the system checks if the security gate 58 is closed and that the latch is engaged. If either is false, an alarm is triggered. This alarm may summon a worker to check the machine. The system also checks for a motor overload, and if this is sensed an alarm is triggered. If these steps are passed, the system “Opens security gate via air valve” and a “Limit switch double checks security gate is open.” If the gate is not open, the alarm is triggered. If the gate is open, the “System runs output conveyor for 8 seconds until product is off of the output conveyor.” The checkout conveyor 52 may move at the same time to move product coming down the ramps 57 away from the ramps. Then, the “System checks output conveyor sensor to ensure product dispensed.” The output conveyor sensor may take a variety of forms. If the product has not been dispensed, the system returns to the prior step, as shown. If product has been dispensed, the “System closes security gate” 58 and a limit switch confirms it is closed. If it is not closed, an alarm may be triggered or the system may try again to close the gate.

If these steps are passed, the system continues to a stage for removal of product by the customer. First, the mag-latch on the checkout cover is released and the checkout cover 54 is opened using the air valve 59. Then, the “System confirms opening of the checkout cover”, such as by using a sensor. If it is not open, an alarm may be triggered and/or the system may try again to open the cover. Next, the “Customer removes product” and the light sensor confirms when product has been removed. Once the checkout conveyor is clear, the “System closes checkout cover” and “Limit switch confirms checkout cover is closed”. Again, an alarm may be triggered if needed. If the cover is closed, the latch is activated and the transaction is complete.

The produce supports 30 may take a variety of forms. One preferred design for a produce support is the subject of Applicants' co-pending patent application Ser. No. 61/721,876 and 61/721,923, the entire content of both are incorporated herein by reference. However, other types and designs of produce supports may be used in alternative embodiments.

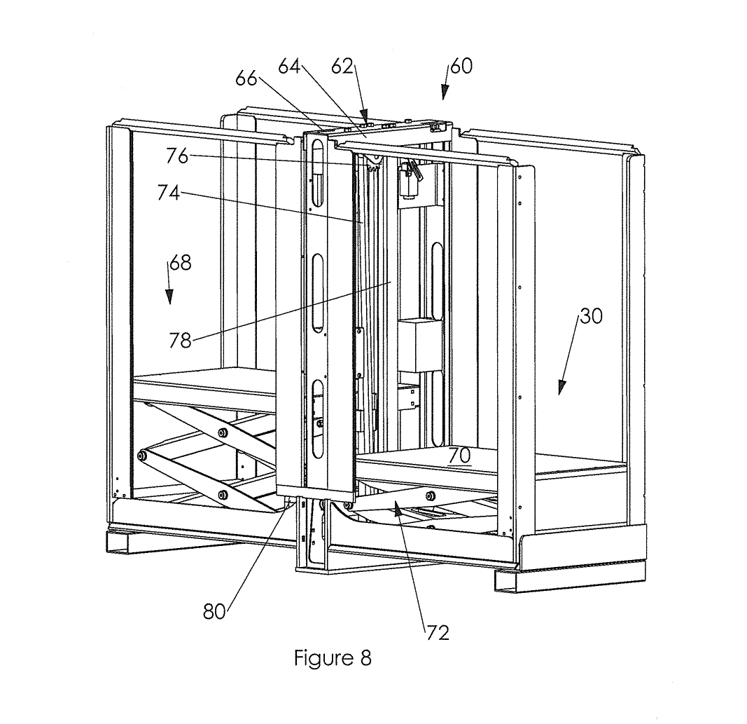

Referring now to FIG. 8, a produce support 30 will be described in more detail. In this embodiment, the produce support 30 forms part of a vertically adjustable platform system 60. The system 60 includes a lifting tower 62 having opposed faces 64 and 66. The produce support 30 is adjacent the face 64 and an additional produce support 68 is adjacent the other face 66. Each of the produce supports is moved upwardly and downwardly by the lifting mechanism in the lifting tower. The support 30 includes a platform 70 that is disposed on the upper end of a scissors mechanism 72. The lifting mechanism includes a chain 74 that extends around an upper chain sprocket 76 near the top of the tower 62 and a lower chain sprocket, not shown, near the bottom of the tower. A vertical guide bar 78 extends between the upper and lower ends of the tower and slidably receives a lifting block that is interconnected with the platform 70. A lifting block is also connected to the chain 74 such that movement of the chain causes the lifting block to move upwardly and downwardly on the guide bar 78 and thereby causes upward and downward movement of the platform 70.

Unlike traditional scissors lift mechanisms, the platform is not lifted by the scissors mechanism, but instead the scissors mechanism stabilizes the platform and is raised and lowered by the motion of the lifting block. A motor, preferably with an electric brake, and gear box 80 is disposed under the platform 70 at the bottom of the tower and extends generally perpendicular to the face 64. This motor and gear box drive the lower chain sprocket, thereby moving the chain and the attached platform. The lifting mechanism is the only mechanism responsible for moving and maintaining the position of the platform. A similar lifting mechanism is housed in the same tower 62 and moves the other produce support 68. As shown, the tower 62 takes very little space between the produce supports, thereby allowing produce to fill most of the horizontal display plane. In some embodiments, the platforms 70 have a side-to-side dimension of approximately 16 inches, a front-to-back dimension of approximately 25 inches, and the tower has a thickness between the faces 64 and 66 of approximately 3½ inches. As such, the tower takes up only a small fraction of the total horizontal display plane.

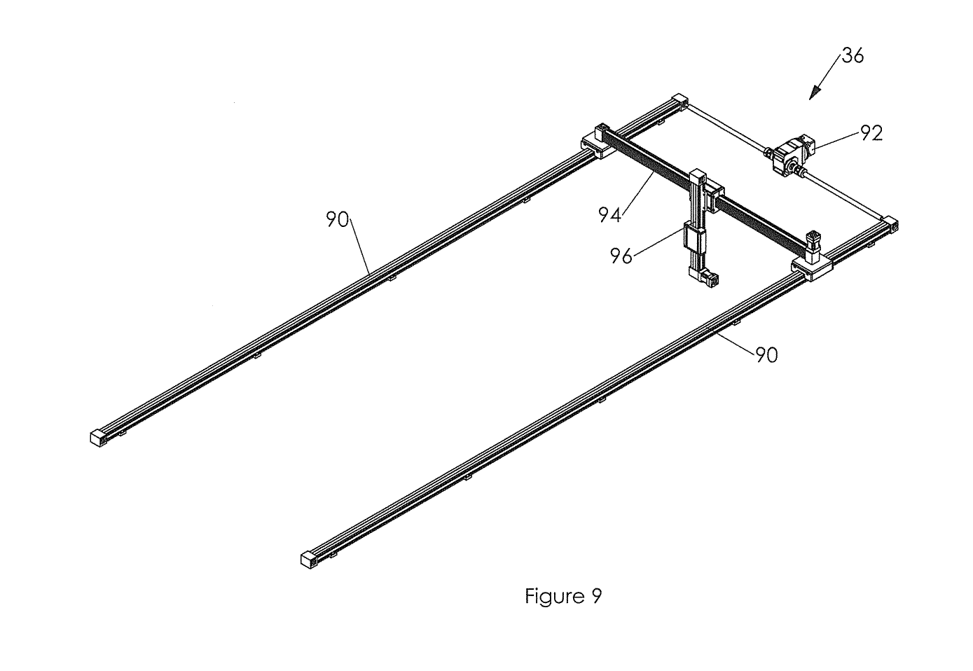

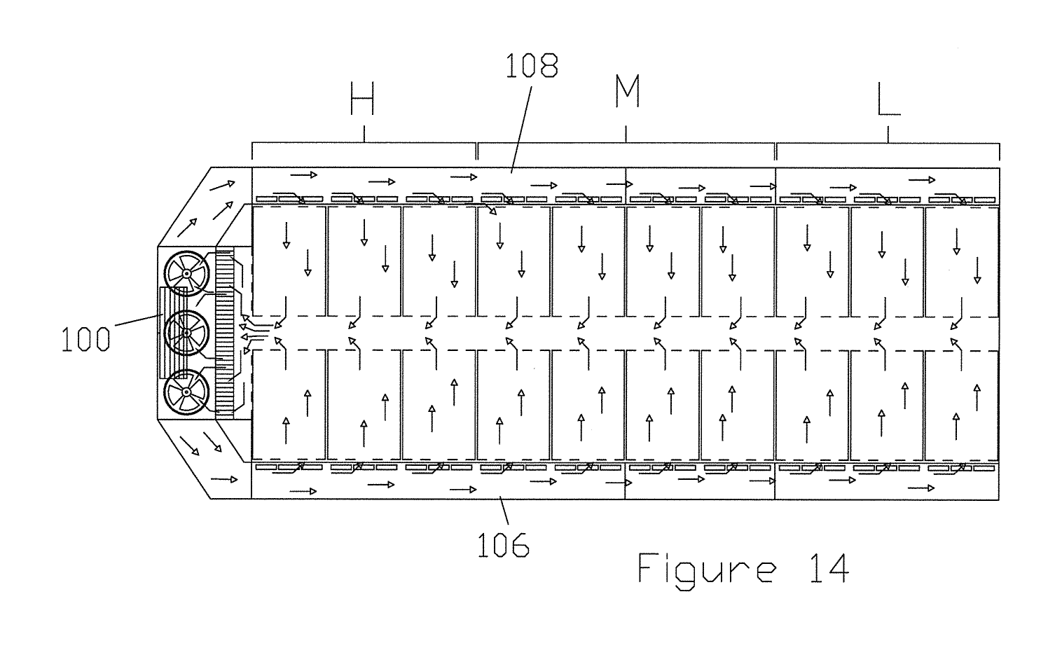

Referring now to FIGS. 9-12, the retrieval system will be described in more detail. FIG. 9 shows the gantry 36. It includes a pair of parallel rails 90 that run end-to-end in the housing and are supported by the perimeter frame 28. These allow movement of the gantry from side-to-side in the housing. The rails 90 include linear belt actuators driven by a gantry drive 92. A fore-aft rail 94 extends between the rails 90 and allows gantry movement front-to-back in the housing. Again, a linear belt actuator is provided for this movement. A portion of the pick-up arm is shown at 96 in FIG. 14. It is operable to move upwardly and downwardly with respect to the fore-aft rail 94. The vertical movement is also preferably provided by a linear belt actuator.

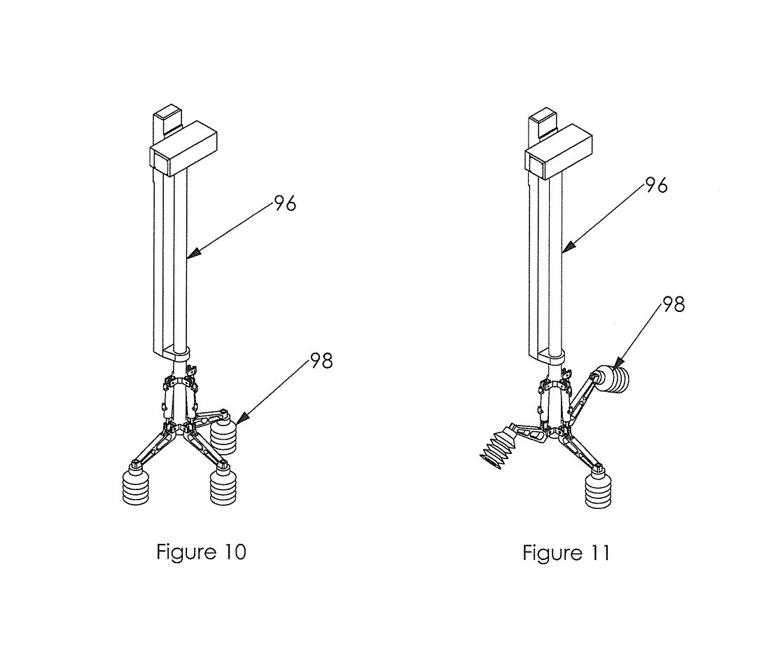

FIGS. 10 and 11 show the pick-up arm 96 in more detail. The arm 96 has a retrieval end 98 for grasping produce packages. In the illustrated embodiment, the retrieval end 98 includes three suction devices for attaching to a produce package. These suction devices may be individually moved upwardly and downwardly, with FIG. 11 showing two of the devices retracted upwardly. Depending on the shape and size of the package to be retrieved, one or more of the suction devices may be used. A combination of grasping devices may be used, such as finger grippers, tweezers, rotary lock grippers, forks and scoops of all imaginable shapes. Also, an automated end of arm tool changer may be incorporated into the system for the ability to handle a larger variety of products. In some embodiments, the end of arm tool with the attachments rotates, tilts, and reaches out, telescoping and/or tucks away, or curls up and away. This allows for multiple devices to be mounted on the end of arm tool changer.

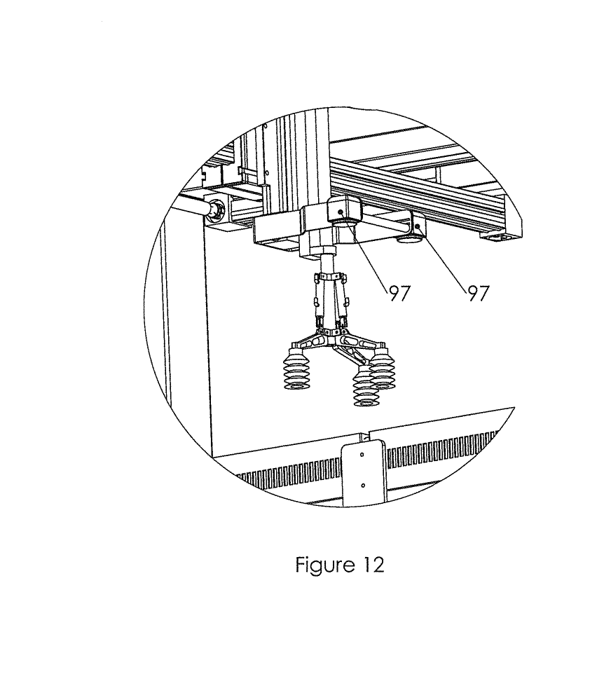

In some embodiments, the pick-up arm includes a vision system that allows the control system to “see” the location of the retrieval arm and to assist in proper locating and grasping of a package of produce. FIG. 12 shows one approach to a vision system, including two cameras 97 mounted to the gantry. The cameras 97 can “see” each of the suction devices, and may be movable and/or tiltable. In use, the control system for the machine knows the location of each product in the display plane, but containers may shift slightly. The vision system may be used to compensate for any shifts. The gantry moves the arm to the area where a product should be located. The system pauses and the vision system looks to check the location of the product and the gantry adjusts as needed. The vision system can be trained to “target” particular characteristics of the products. For example, a particular sticker may be applied to the product in a known location, preferably consistent within 0.25 inches, and the vision system will use this sticker as a target. Other vision systems and approaches may be used. As will be clear to those of skill in the art, other types of retrieval systems may be used, as long as they are capable of retrieving individual packages of produce and delivering them to the output area. In some embodiments, an automated program will use one type of gripper or retrieval device and, if it fails to retrieve the product, another gripping device will be activated for assistance.

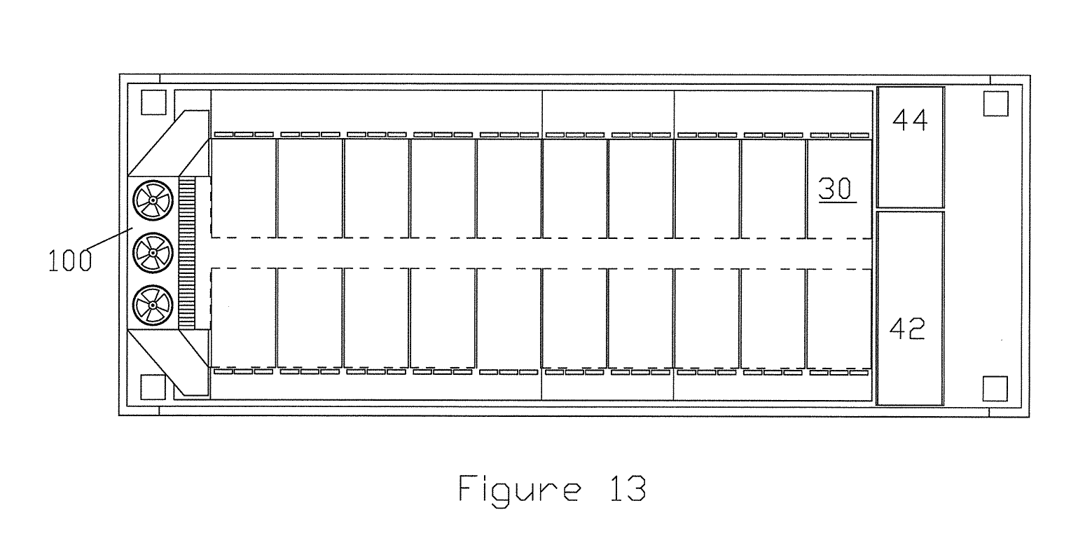

The present invention further provides a climate control system for controlling the climate inside the housing. Preferably, the climate control system allows for improved storage and maintenance of the produce. FIG. 13 provides a top view of the automated produce department showing the relative positioning of the climate control system, the produce supports 30, the output conveyor 42 and the disposal conveyor 44, for one embodiment. The climate control system includes a conditioning unit 100 that is positioned at the end of the housing 12 farthest from the conveyors. Other arrangements are also possible.

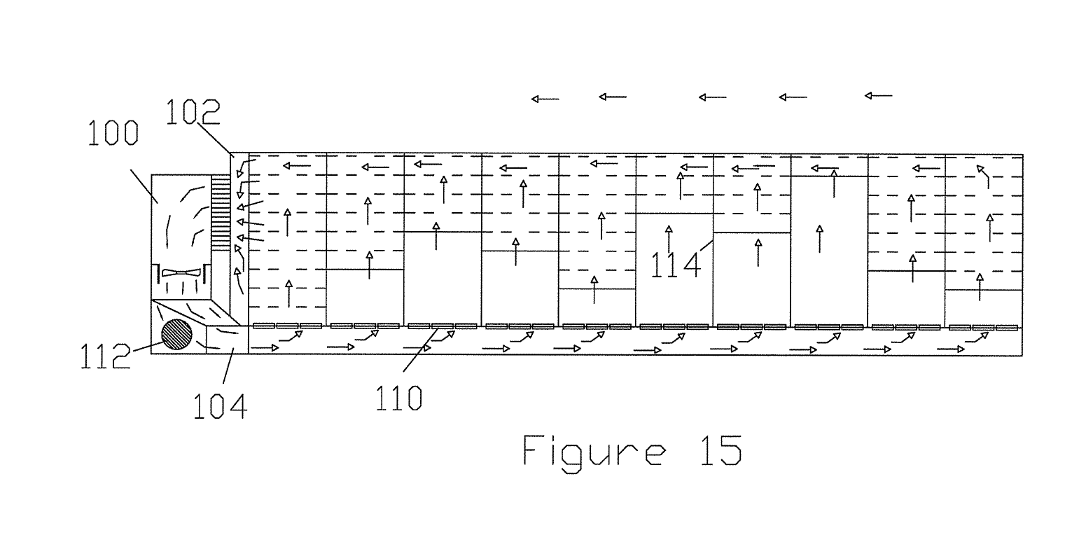

Referring to FIGS. 14 and 15, the climate control system and its operation will be discussed in more detail. FIG. 14 provides a top view of the climate control system and the produce supports and FIG. 15 provides a side view. The conditioning unit 100 has an inlet 102 and an outlet 104. Two supply ducts 106 and 108 are connected to the conditioning unit outlet and provide conditioned air to various areas of the housing. In the illustrated embodiment, the two supply ducts 106 and 108 are provided adjacent the outer edges of the produce supports with outlets all along their length. These outlets may take a variety of forms. In some embodiments, adjustable louvers 110 are provided in the upper side of the ducts. The louvers may be manually adjustable or automated and under the control of the control system.

The inlet 102 to the conditioning unit 100 is in fluid communication with the end of the display area closest to the conditioning unit. As such, it draws air from the area between and underneath the produce supports. For example, if a product support is lifted to a high position, the area under the platform provides a flow path back to the inlet. The covers, such as 100 in FIG. 4, on the ends of the scissors mechanisms limit airflow between the area under the platforms and the perimeter area of the housing. Air may also flow through the towers and through the trays of produce. Alternatively, an air return tunnel maybe provided between the supports and be connected to the conditioning unit inlet.

FIGS. 14 and 15 include arrows indicating potential flow paths for air. As shown, conditioned air flows from the outlets of the supply duct up the outside of the produce supports and through the gaps between the packages of produce. This conditioned air is then drawn back to the conditioning unit. The air may flow sideways through the produce displays as well as downwardly through the supports and through the towers.

As shown in the figures, the conditioned air may be provided to all of the produce areas and then drawn from one end towards the other. In some embodiments, the climate control system provides for control of ethylene. As known to those of skill in the art, some produce produces high levels of ethylene, which is a ripening agent. Tomatoes are an example of a high ethylene product. If ethylene is allowed to collect and remain around produce, the produce may degrade more quickly than if the ethylene is removed. For this purpose, the display area may be defined as having a high ethylene zone and a low ethylene zone, possibly with a medium ethylene zone also provided. FIG. 14 indicates areas of the enclosure that may be considered a high ethylene zone H, a medium ethylene zone M, and a low ethylene zone L. The high ethylene zone H is preferably closest to the conditioning unit 100 and the low ethylene zone L is farthest from the conditioning unit. As such, air flows to the low ethylene zone and is then drawn back through the medium and high ethylene zones. Therefore, ethylene from the produce in the high ethylene area generally does not pass over or through the low ethylene area on its way to the conditioning unit.

The conditioning unit preferably removes or neutralizes the ethylene. Those of skill in the art recognize various approaches for the removal and neutralization of ethylene. One approach is to inject ozone into the air to naturally preserve the produce and to destroy the ethylene. An ozone unit 112 is shown in FIG. 15. Preferably, the ethylene is substantially removed or neutralized in the conditioning unit before conditioned air is returned to the supply duct.

As will be clear to those of skill in the art, the conditioning unit also adjusts the temperature and/or humidity of the air. Typically, the air is chilled, though if the housing is placed outdoors, heating may also be required either in the conditioning unit or elsewhere.

The climate control system may also provide for different temperature regions within the housing. Some types of produce, or other products, may benefit from lower temperatures than other types of produce and products. The temperature within the housing may be controlled by dampers in the supply duct so that differing amounts of conditioned air are provided to different regions of the housing. Adjustable outlet louvers also allow for differential temperature control. Temperatures in various parts of the housing may be adjusted by the control system since the automated produce department may be used for different types of produce at different locations or at different times of the year. Airflow dividing walls 114 may be provided between produce supports, if desired, to better define different temperature regions. These dividing walls may be removed or installed as needed.

In some embodiments, sensors are provided in various locations in the housing for sensing temperature, humidity, ozone level, ethylene level and/or other factors. These sensors may communicate with a control system for automated control or they may be used for monitoring and manual adjustments may be made.

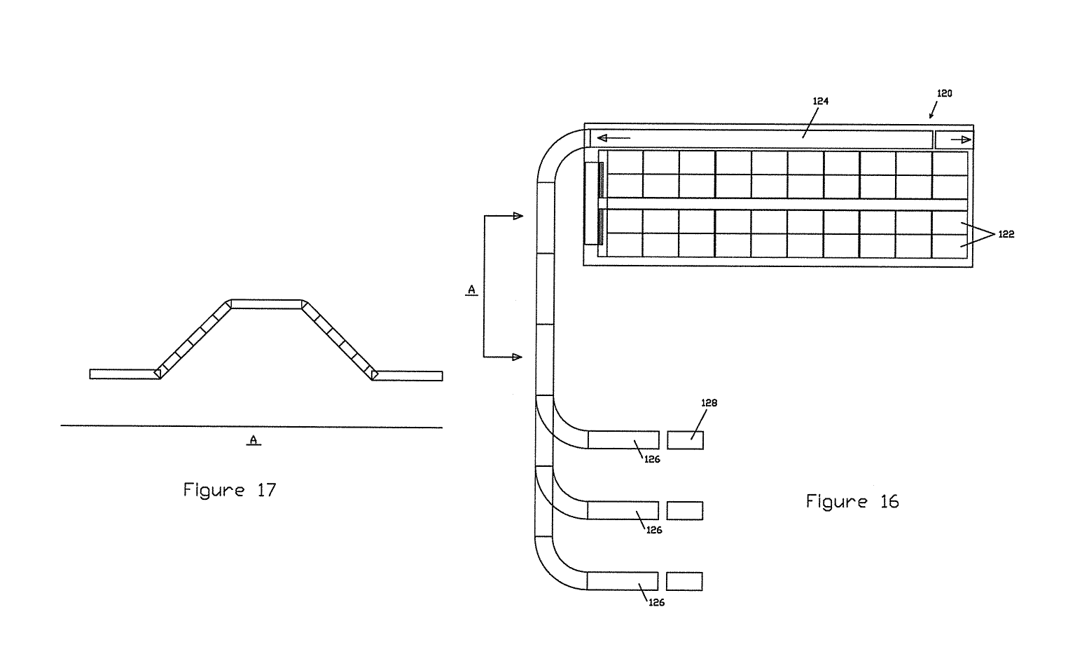

A produce vending machine in accordance with the present invention may form part of a larger vending system, such as shown in FIG. 16. The example system includes a large vending machine 120, similar to the machine 10 discussed above, but with two sets of produce supports 122. The supports may be larger and oriented differently than in the earlier embodiment. In this version, an output conveyor 124 is provided at the back of the machine 122. This conveyor conveys product to multiple checkout areas 126. FIG. 17 shows a side view of part of the conveyor, illustrating that it may go up and over an aisle or other obstacle between the machine 120 and checkout areas 126. Multiple terminals 128 may be provided for customer use. In this embodiment, product may be provided by the machine 120 and moved to multiple checkout areas, thereby serving more customers.

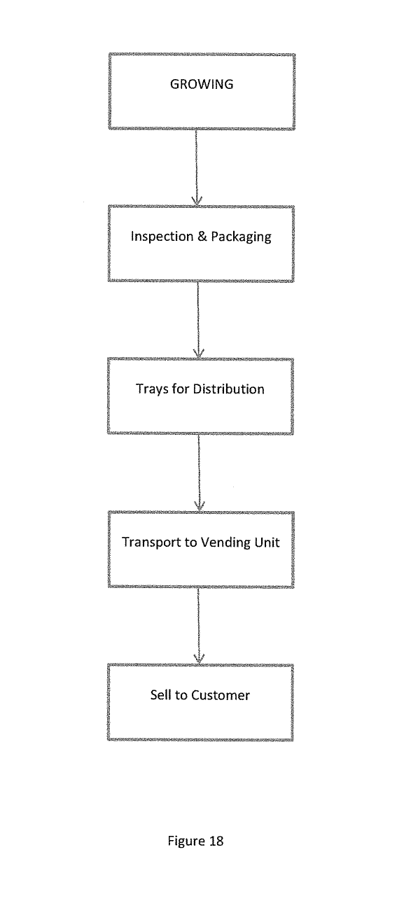

The present invention also provides a “farm-to-fork” method of distributing produce. Currently, produce is handled multiple times between picking and sale, and the produce may be contaminated, damaged, or delayed. Use of an automated produce department as described above allows improvements in the distribution of product. FIG. 18 illustrates exemplary steps of an improved distribution process. The first step is growing of the product. In preferred embodiments, the product is grown in a controlled area, such as a greenhouse, and entry is restricted to authorized personnel. Good Agricultural Practices (GAP) are followed, including personal hygiene requirements and restricted practices in the greenhouses. Food safety audits may be performed by trusted and/or certified third party organizations to assure that the produce meets food safety standards. Bacterial testing may be conducted by swab analysis and water analysis. The most recent advances in greenhouse technology may be employed.

As a next step, the produce is inspected and packaged. Preferably, this step is performed in the same, or an adjacent, facility as the growing step and under the same level of control. This allows the produce to be tracked from the picker to the package and further to the retail customer. The produce is cooled and humidity levels are monitored to ensure freshness is maintained. The greenhouse, packaging facility and storage, if used, are audited to ensure traceability. The packaging protects the produce from damage and contact by humans and allows it to be vended from the vending machine.

The next step is to place the packaged produce into trays for distribution. These trays will be placed into the automated produce department, and are preferably sized and designed for this purpose. As with the packaging step, the produce is cooled and stored in a climate controlled environment during this process, and GAP is followed throughout the grow/pack/ship process. The trays are preferably open and allow air circulation to maintain freshness.

Transport is a next step, with the produce being in packages and the packages in trays ready for the automated produce department. The trays may be arranged in stacks as they will be loaded into the department, further reducing handling at the distribution point. Again, the produce is cooled and stored in a climate controlled environment during the shipping step. Typically, this will be a truck with a climate control system. Preferably, these trucks are used only for produce, to eliminate contamination. Further, the trucks may be owned and operated by the same entity that grows and packages the produce, in order to increase overall control. Either way, the shipper signs off on the cleanliness of the truck and is part of the traceability process. The produce packaging, including the trays, are designed for stability during shipping to avoid damage.

Finally, the produce is sold to the customer. This step makes use of the automated produce department described above. The display area inside the housing may be sterilized prior to use, such as by using the ozone system. The automated produce department has a climate controlled environment, such that the produce is almost continuously held under optimal conditions from the time it is packaged until the time it is purchased. The delivery person loads the produce department by opening the doors, removing produce that is scheduled for removal, and refilling the supports with stacks of trays. The control system of the machine may have a “refill mode” wherein produce is consolidated to trays in one area of the machine to allow other areas to be refilled. The control system may also keep track of the age of all produce to allow proper rotation of stock and disposal of produce that is past a sell-by date. The machine's retrieval system may also assist in the restocking by moving produce as needed.

As will be clear to those of skill in the art, the farm-to-fork process described herein allows product to be distributed without any handling of the individual produce from the time that it is packaged until it is purchased, and allows the produce to be held under climate controlled conditions almost the entire time from when it is picked to when it is sold. These features allow improved freshness, safety, and traceability of the produce.

The present invention also provides for centralize monitoring and control of the automated produce departments. Each machine will have an Internet connection to a central server, allowing the server to track inventory and the status of the machines. Based on this inventory tracking, shipments of appropriate restocking produce may be scheduled by the grower and shipper.

The present invention also provides for use of the automated produce vending machine from mobile phones and tablets, as well as from computers that are remote from the machine. A customer may access an account from any web-enabled device. The customer will set up their account with the typical information and then order produce. The customer may pick which machine they will use to pick up the produce and the system can verify the availability of the desired produce. The customer will enter their order, review the order, and confirm it. The customer may then pay for the order using a stored credit card or other payment process. The system will provide a pick-up code that the customer enters when they arrive at the machine. Alternatively, payment may be made at the time of pickup. The machine may assemble the order in advance of the customer's arrival. For example, the selected produce may be retrieved and placed in a waiting order, so that it may be quickly dispensed when the customer arrives. The machine may also “reserve” the customer's selection such that it does not sell out prior to their arrival.

As will be clear to those of skill in the art, the herein described embodiments of the present invention may be altered in various ways without departing from the scope or teaching of the present invention. It is the following claims, including all equivalents, which define the scope of the invention.

1. An automated produce department, comprising:
a housing at least partially enclosing a display area, the housing having at least one viewing window for viewing the display area;
a plurality of produce supports each configured to support a plurality of packages of produce in a vertical stack, the produce supports being disposed in a horizontal array such that the supports cooperate to display produce as a horizontal display viewable through the viewing window;
each of the produce supports comprising a vertically adjustable platform such that the platforms may be adjusted to position an uppermost package of produce in each of the vertical stacks at a display level generally in a display plane, the uppermost packages being viewable through the viewing window;
a retrieval system for retrieving a package of produce from any of the produce supports and delivering the package to an output area.

2. An automated produce department in accordance with claim 1, further comprising:
a plurality of vertically adjustable platform systems, each system having a lifting tower with one of the vertically adjustable platforms being disposed on a first side of each tower and another of the vertically adjustable platforms being disposed on a second side of each tower.

3. An automated produce department in accordance with claim 2, wherein:
the plurality of vertically adjustable platform systems are disposed side by side such that the towers form a central axis of the horizontal array of supports.

4. An automated produce department in accordance with claim 2, wherein:
the plurality of vertically adjustable platform systems each further includes a first scissors mechanism disposed on a first side of each tower and a second scissors mechanism disposed on a second side of each tower, the platforms each being disposed on an upper end of a scissors mechanism.

5. An automated produce department in accordance with claim 4, wherein:
the plurality of vertically adjustable platform systems each further includes a lifting mechanism disposed generally in the tower, the lifting mechanism being connected to the platforms for vertically adjusting the position of the platforms.

6. An automated produce department in accordance with claim 1, further comprising:
an output conveyer disposed in the housing adjacent the horizontal array of produce supports, the output conveyer having a generally horizontal upper surface defining the output area for receiving packages of produce.

7. An automated produce department in accordance with claim 6, further comprising:
a checkout area defined at least partially outside the housing, the output conveyer conveying produce to the checkout area.

8. An automated produce department in accordance with claim 7, further comprising:
a checkout cover selectively covering the checkout area, the checkout cover having a closed position preventing access to the checkout area by a customer and an open position allowing access to the checkout area by a customer.

9. An automated produce department in accordance with claim 7, further comprising:
a checkout conveyer having an upper surface defining the checkout area.

10. An automated produce department in accordance with claim 1, wherein:
the retrieval system comprising a retrieval gantry movable horizontally above the supports and a pickup arm vertically movable to pick up a package from a support and lift the package above the supports, the pickup arm having a retrieval end.

11. An automated produce department in accordance with claim 1, further comprising:
a climate control system operable to control the climate in the display area, the climate control system including a conditioning unit with an inlet and an outlet, and a supply duct in fluid communication with the outlet of the conditioning unit, the supply duct having a plurality of outlets, each outlet being disposed adjacent one of the produce supports.

12. An automated produce department in accordance with claim 11, wherein:
a high ethylene zone and a low ethylene zone are each defined within the housing, at least some of the produce supports being disposed in the high ethylene zone and some of the produce supports being disposed in the low ethylene zone, the climate control system directing airflow within the housing such that air flows from the low ethylene zone to the high ethylene zone and then into the inlet of the conditioning unit, the conditioning unit neutralizing or removing at least some of the ethylene from the air before the air flows through the supply duct.

13. An automated produce department in accordance with claim 12, wherein:
the conditioning unit is disposed toward a first end of the housing, the high ethylene zone being closer to the conditioning unit and the low ethylene zone being farther from the conditioning unit.

14. An automated produce department in accordance with claim 1, further comprising:
an ordering terminal for use by a customer, the ordering terminal including an input screen for inputting a selection and a payment mechanism for accepting payment.

15. An automated produce department, comprising:
a housing at least partially enclosing a display area, the housing having at least one viewing window for viewing the display area;
a plurality of produce supports each configured to support a plurality of packages of produce in a vertical stack, the produce supports being disposed in a horizontal array such that the supports cooperate to display produce as a generally horizontal display viewable through the viewing window;
an output conveyer disposed in the housing adjacent the horizontal array of produce supports, the output conveyer having a generally horizontal upper surface defining an output area for receiving packages of produce; and
a retrieval system for retrieving a package of produce from any of the produce supports and delivering the package to the output area.

16. An automated produce department, comprising:
a housing at least partially enclosing a storage area, a high ethylene zone and a low ethylene zone are each being defined within the housing;
a plurality of produce supports each configured to support a plurality of packages of produce;
at least some of the produce supports being disposed in the high ethylene zone and some of the produce supports being disposed in the low ethylene zone;
a climate control system having a conditioning unit with an inlet and an outlet, the climate control system directing airflow within the housing such that air flows from the low ethylene zone to the high ethylene zone and then into the inlet of the conditioning unit, the conditioning unit neutralizing or removing at least some of the ethylene from the air before the air flows through the outlet.
